(19) United States
(12) Patent Application Publication
(10) Pub. No.: US 2026/0312820 A1
(43) Pub. Date: Oct. 8, 2026

(54) AGENT-BASED PRODUCTION MODELING WITH DETERMINISTIC AND PROBABILISTIC VERIFICATION GATING

(71) Applicant: EnergySolutions Al LLC, Tulsa, OK (US)

(72) Inventor: Michael Dean Orr, JR., Owasso, OK (US)

(21) Appl. No.: 19/577,473

(22) Filed: Mar. 25, 2026

Related U.S. Application Data
(60) Provisional application No. 63/784,285, filed on Apr. 7, 2025.
(60) Provisional application No. 63/923,867, filed on Nov. 24, 2025.
(60) Provisional application No. 63/923,877, filed on Nov. 24, 2025.
(60) Provisional application No. 63/923,884, filed on Nov. 24, 2025.
(60) Provisional application No. 64/002,881, filed on Mar. 11, 2026.

(51) Int. Cl. H04L 9/32; H04L 9/00

(52) U.S. Cl. CPC H04L 9/3236; H04L 9/50; H04L 2209/56

(57) ABSTRACT

Apparatus and method for production reconciliation in a low trust environment, such as but not limited to a multistream hydrocarbon production system. A reconciliation run is executed by a data plane of a processor-based system to generate candidate outputs representing reconciled production values, and to assemble a corresponding evidence bundle keyed by a run_id. A truth gate module evaluates the candidate outputs using at least one deterministic validation criterion and at least one probabilistic validation criterion to generate a composite truth score. Promotion of the candidate outputs to a validated semantic state results in posting to a system of record for settlement, such as a private or public distributed ledger. Promotion is blocked either due to failure of the deterministic validation criterion or the composite truth score falling below the predetermined threshold. Exception events are handled via human intervention using an alert register of a user plane.

### RELATED APPLICATIONS

The present application makes a claim of domestic priority to the following co-pending U.S. Provisional Patent Applications No. 63/784,285 filed Apr. 7, 2025; No. 63/923,867 filed Nov. 24, 2025; No. 63/923,877 filed Nov. 24, 2025; No. 63/923,884 filed Nov. 24, 2025; and No. 64/002,881 filed Mar. 11, 2026. The contents of each of these applications are hereby incorporated by reference.

### BACKGROUND

Oilfield production systems often produce complex data streams reflecting the flow of hydrocarbons and water through various processing stages such as wells, separators, tank batteries, gathering systems, processing plants, etc. Each stage introduces new measurements, operational events, and potential sources of error. Differences in instrumentation, timing, data quality, and operational practices can lead to conflicting or incomplete datasets that complicate production reporting, allocation, and regulatory compliance. As production networks grow in scale and complexity, these challenges become increasingly difficult to manage using traditional tools.

Existing production accounting solutions often depend on static business rules, manual adjustments, or post-hoc reconciliation processes that lack transparency and repeatability. Such systems are not well-suited to environments where measurement conditions change dynamically or where multiple product streams must be reconciled across physical and commercial boundaries. Accordingly, there is a continuing need for improved approaches that can model the physical production system, evaluate measurement evidence, and reconcile multistream production data in a deterministic and auditable manner.

### SUMMARY

Various embodiments of the present disclosure are generally directed to systems and methods for production reconciliation in a low trust environment, such as but not limited to a multistream hydrocarbon production environment.

Without limitation, some embodiments provide a computer-implemented method for validating a reconciliation run in an agent-based production reconciliation system. The method operates by executing, by a data plane of the system, a reconciliation run associated with a unique run identifier (run_id) to generate candidate outputs representing reconciled production values derived from accumulated measurements of a physical production system. The method assembles, for the reconciliation run, an evidence bundle keyed to the run_id and comprising raw measurements, intermediate calculations, agent validation records, and a cryptographic hash of input data.

A truth gate executed by a programmable processor evaluates the candidate outputs using at least one deterministic validation criterion that produces a non-overridable pass/fail result based on schema-level conditions of the accumulated measurements, and at least one probabilistic validation criterion that generates a numerical score representing a likelihood that the candidate outputs are trustworthy. The probabilistic validation criterion include at least a reconciliation-history factor derived from prior reconciliation runs associated with the run_id and an evidence-bundle integrity factor derived from comparing the cryptographic hash to a stored hash of the evidence bundle.

The truth gate proceeds to compute a composite truth score for the reconciliation run based on the probabilistic validation criterion, and promotes the candidate outputs to a validated semantic state responsive to the deterministic validation criterion passing and responsive to the composite truth score exceeding a predetermined threshold. The truth gate further operates to block the candidate outputs from promotion responsive to either the deterministic validation criterion failing or the composite truth score falling below the predetermined threshold. Promotion of the candidate outputs to the validated semantic state authorizes posting of the candidate outputs to a system of record for settlement, such as a private or public blockchain-based distributed ledger.

These and other features and advantages of various embodiments can be understood from a review of the following detailed description in conjunction with a review of the accompanying drawings.

### BRIEF DESCRIPTION OF THE DRAWINGS

FIG. 1 is a functional block diagram of a physical oil and gas production system which is modeled and monitored by an enterprise resource planning (ERP) management system in accordance with various embodiments of the present disclosure.

FIG. 2 shows elements from FIG. 1 in accordance with some embodiments.

FIG. 3 is a network diagram showing device and network interconnections of the system in some embodiments.

FIG. 4 shows hardware and software aspects of devices from FIG. 3 in some embodiments.

FIG. 5 is a generalized architecture of the system in some embodiments.

FIG. 6 is a schematic representation of a web application (app) to model and display operation of the system on a local user device in some embodiments.

FIG. 7 is a detailed architecture of the system in accordance with further embodiments.

FIG. 8 is a functional representation of aspects of a truth gate module of FIG. 7 in some embodiments.

FIG. 9 is a functional representation of a multi-tiered storage architecture utilized by the system in some embodiments.

FIG. 10 is a table format for an on-chain revenue distribution contract utilized by the system in accordance with some embodiments.

FIG. 11 is a table format for a Run Registry utilized by the system in accordance with some embodiments.

FIG. 12 shows a table format for a bundle registry index utilized by the system in accordance with some embodiments.

FIG. 13 shows a table format for a bundle content utilized by the system in accordance with some embodiments.

FIG. 14 shows a table format to illustrate bidirectional traceability using the table formats of FIGS. 10-13 in some embodiments.

FIG. 15 is a flow chart for a reconciliation processing routine illustrative of steps that can be carried out by various embodiments of the present disclosure to provide reconciliation processing for a production system such as in FIG. 1.

### DETAILED DESCRIPTION

In a representative embodiment, the system models a physical production environment in which a single wellbore contains multiple completions. Each completion represents a distinct engineered interval within the well that contributes a defined portion of the total measured production. Ownership attributes such as Working Interest (WI), Net Revenue Interest (NRI), and Lease Operating Expense (LOE) obligations are associated at the well level and subsequently allocated across completions and owners.

The system is configured to model and monitor a number of distinct product streams. Without limitation, some embodiments provide the following streams: gas, oil, natural gas liquids (NGL), condensate, and water. Each stream follows a unique physical path through equipment, measurement points, and commercial endpoints. Other types and combinations of streams can be modeled and monitored.

The system models each physical component in the system as a semantic entity, and measurements and other monitoring actions are each modeled as a semantic event. These semantic entities and events form the basis of a digital twin of the physical plant which employs a semantic model that defines the entities, events, processes, stages, workflows, validations, and business functions that govern the behavior of the digital twin. The semantic model serves as an executable grammar for the system and defines the structure of each product stream, the sequence of physical stages, the expected measurements at each stage, and the rules governing allocation, reconciliation, and validation.

The semantic model also defines the behavior of agents within the system, which provide automated calculations, reconciliations, and other related functions. The agents take a number of forms. Measurement agents extract and normalize raw data from field systems. Allocation agents apply completion splits, shrink factors, fuel usage, BS&W adjustments, ownership allocations, and LOE distributions. Reconciliation agents ensure that physical balances hold, such as gas in equaling residue gas plus NGL plus fuel plus shrink, or oil out equaling oil sold plus tank stock change. Validation agents apply deterministic rules to verify that all reconciled outputs satisfy invariants, tolerances, and business constraints.

The system separates machine-driven workflows from human-driven workflows through the use of separate internal structures referred to herein as a user plane and a data plane. The user plane allows human actors to configure, audit, and use the system. Different levels of access and interaction are provided for various human actors, which without limitation can include auditors, compliance reviewers, data engineers, configuration specialists, operators, tenants, customers, and administrators. The data plane is the machine-side engine and provides data input, analysis, monitoring and validation/posting capabilities.

Orchestrator modules apply management control to the respective user plane and data plane. More particularly, a durable backend orchestrator executes long-running, durable machine workflows such as data ingestion, agent execution, reconciliation, and validation upon the data plane. A business process management (BPM) orchestrator manages human interactions with the user plane such as approvals, exception handling, and incident resolution. Both orchestrators operate over the same semantic model and share a unified run context.

Each execution of a reconciliation process is associated with a unique run identifier (run_id). The run_id is propagated across all workflows, events, measurements, and postings, and is stored in a Run Registry that maps run_id to process, stage, step, and timing information. This run spine provides a durable lineage that ties together all machine and human actions, all agent computations, all evidence artifacts, and all final postings.

During execution, the system generates evidence bundles that contain all artifacts relevant to a reconciliation run. These may include raw measurements, intermediate calculations, model prompts and responses, validation results, human decisions, attachments, and posting records. Evidence bundles are stored in an object storage system with versioned hashes. Each bundle is keyed by run_id and is accessible to auditors, compliance reviewers, and operations personnel. The evidence bundles enable replay, verification, and regulatory audit of any reconciliation run.

In further embodiments, the data plane is provided with an internal truth gate module that provides a deterministic validation and posting boundary. Agents may generate candidate outputs such as reconciled volumes, allocated ownership shares, revenue distributions, posting instructions, etc., but these candidates cannot directly modify systems of record. Instead, all candidate outputs are submitted to the truth gate for agent and, as required, human validation.

The truth gate validates candidate outputs against curated truth surfaces, semantic validations, and deterministic rules. Only if all validations pass does the truth gate commit the outputs to the system of record. Posting operations are idempotent and may include compensation logic to correct prior postings if discrepancies are later detected. If validation fails, the truth gate raises an exception to the human workflow system via the user plane for review and approval.

During operation, the system ingests measurements from the physical plant, applies completion and ownership allocations, reconciles multi-stream flows, validates all results, and posts final values to target systems. Each step is governed by the semantic model, executed by agents, orchestrated by machine and human workflows, and recorded in the run spine. Evidence bundles provide full transparency and auditability. The truth gate ensures that only validated, deterministic outputs are committed.

The various embodiments of the present disclosure provides several novel architectural elements that distinguish it from conventional production accounting, allocation, and reconciliation systems. These include but are not limited to the following aspects.

Run Spine and Evidence Bundles: the system employs a unified run spine that propagates a single run_id across all machine workflows, human workflows, events, measurements, agent computations, and postings. Evidence bundles keyed to the run_id contain all artifacts relevant to a reconciliation run, including versioned hashes. This enables deterministic replay, verification, and regulatory audit of AI-assisted workflows.

Truth gate as a Deterministic Commit Boundary: the system introduces a formal truth gate that separates AI-generated candidate outputs from deterministic posting operations. Candidate outputs are validated against curated truth surfaces and semantic validations. Only validated outputs may be committed to systems of record. Posting operations are idempotent and may include compensation logic. This architecture ensures safety, correctness, and auditability in AI-assisted reconciliation.

Semantic Model as Executable Reconciliation Grammar: the system uses a unified semantic model that defines entities, events, processes, stages, workflows, validations, and agent behaviors. The semantic model drives both machine and human workflows, validation logic, agent configuration, and UI behavior. This provides a single source of truth for all reconciliation logic and enables consistent, explainable, and extensible operation across heterogeneous systems.

In further embodiments, a distributed ledger is employed to record verified transactional data. The distributed ledger may be part of a separate, third-party blockchain settlement system agreed upon by the parties to facilitate transactions, including but not limited to a selected cryptocurrency or other payment mechanism.

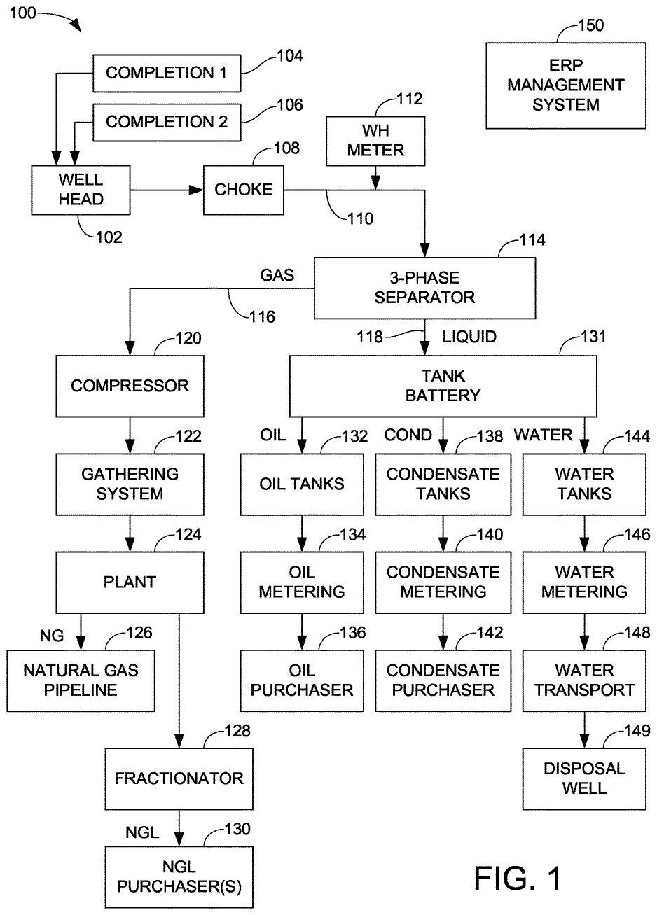

These and various other features and advantages of present embodiments can be understood beginning with a review of FIG. 1 which illustrates an example physical oilfield production system 100. The system 100 is merely illustrative of the types of systems in which the various embodiments of the present disclosure can be employed for process monitoring and control, so it will be appreciated that the various embodiments disclosed herein are not necessarily limited to an oil and gas production environment. It will be appreciated that the diagram in FIG. 1 is highly simplified, and that any number of additional components can be included but have been omitted for purposes of clarity of explanation.

In this particular example, an oil and gas production well produces a stream of liquid and gas components that ultimately result in five different monitored hydrocarbon-based streams: (1) natural gas (NG), (2) natural gas liquids (NGL), (3) oil, (4) condensates, and (5) salt water. While not limiting, it is contemplated that the first four streams result in the generation and allocation of revenue, and the fifth stream (salt water) is a cost center or expense since the water needs to be disposed of using a suitable disposal well or similar mechanism. As will be appreciated, the operation of the system 100 must be carried out in compliance with any number of governmental, regulatory and contractual requirements.

The production system 100 commences with a wellhead assembly (wellhead) 102 having completions 104, 106 that operate to generate production of a multiphase stream of hydrocarbons (production fluid) from a common wellbore coupled to the wellhead 102. While not limiting, each completion may have a different allocation of both costs and revenue from the wellhead 102.

A choke 108 is positioned downstream of the wellhead 102 to regulate a flow rate and pressure of the production fluid along a flowline 110. The regulated fluid from the choke 108 flows through/adjacent a wellhead (WH) meter 112, which measures the raw multiphase production prior to any separation by a three-phase separator 114.

The three-phase separator 114 separates the received fluid into constituent gas phase, liquid hydrocarbon phase, and water phase components. The gas phase components are directed along a gas flowline 116 and the liquid components are directed along one or more liquid flowlines 118.

The separated gas from the gas flowline 116 is directed to a compressor 120. The compressor 120 increases the pressure of the produced gas for delivery into a gathering system 122, which transports the gas to a processing plant 124 such as via a pipeline or similar transport mechanism.

At the plant 124, the gas is processed to produce pipeline-quality natural gas (NG), which is delivered to a natural gas pipeline 126. The plant 126 also extracts a Y-grade NGL stream, which is routed to a fractionator 128 for separation into one or more purity NGL products, which are delivered to one or more NGL purchasers 130 via a suitable transport mechanism (such as an NGL pipeline, truck, etc.). While not separately shown, instrumentation in the form of various sensors, meters, controllers, valves, etc. may be utilized at various points along the NG/NGL processing pathway to provide process control data which will be processed by the system as described below.

The liquid hydrocarbon phase from the separator 114 exits through a liquid outlet and is directed along the liquid flowline 118 to a tank battery 131. The tank battery 131 processes and directs the liquid into constituent components including heavy crude oil, condensate (e.g., lighter liquid hydrocarbons), and salt water.

The oil is directed for collection and temporary storage in oil tanks 132. The oil stored in the oil tanks 132 is metered at an oil metering stage 134 and delivered to an oil purchaser 136 (such as via truck or pipeline). The condensate is directed to a set of condensate tanks 138 and metered at a condensate metering stage 140 for delivery to a condensate purchaser 142. The produced water is flowed to one or more water tanks 144, pending metering at stage 146 and transport 148 (such as via truck) for disposal in a disposal well 149 or other water transport destination.

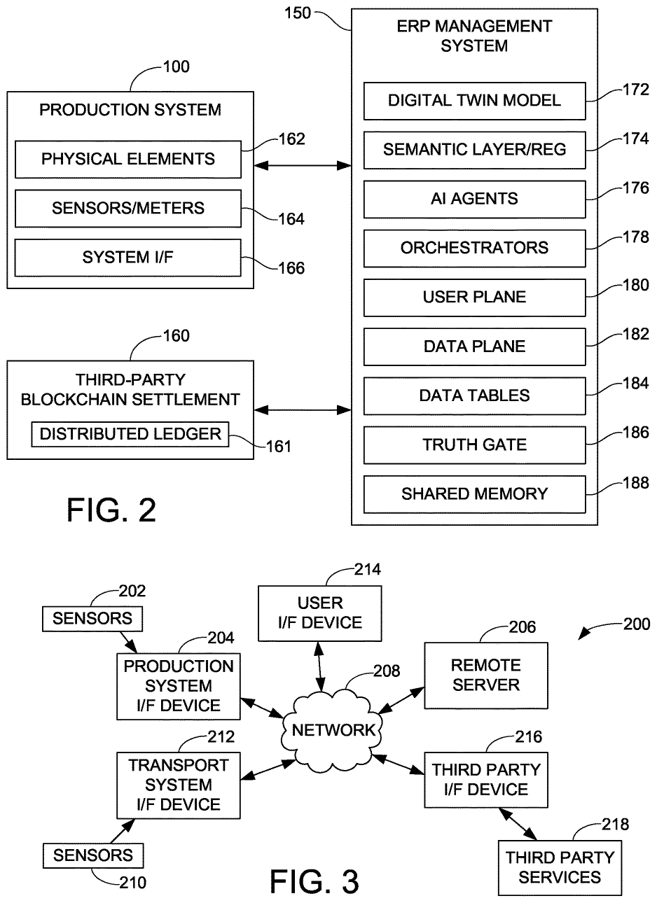

FIG. 1 further shows an enterprise resource planning (ERP) management system 150, which monitors the operation of the system 100 in a manner which will now be discussed beginning with FIG. 2.

FIG. 2 is a functional block representation of aspects of FIG. 1, including the production system 100, the ERP management system 150 and an optional third-party blockchain settlement provider 160 with distributed ledger 161 (e.g., public blockchain, etc.). It will be appreciated that the representative elements in FIG. 2 are merely in accordance with some embodiments, so that the arrangement is illustrative only and the system can be realized in other ways as required. For example, as explained below in alternative embodiments the blockchain settlement block 160 is handled as a private, internal blockchain ledger function accessible to all interested parties and forms a portion of the overall ERP management system 150. In either case, a suitable cryptocurrency or other mechanism can be used to facilitate transfers using owner wallets and/or other known electronic currency transactions.

As noted previously, the production system 100 has various physical elements involved in the production of the hydrocarbon streams described in FIG. 1. These physical elements are collectively denoted at 162. Various sensors, meters and other instrumentation that provide sensing/state data are collectively denoted at 164. The instrumentation 164 collectively communicate the system state data generated thereby via one or more system interfaces (I/F) 166 for interaction with other aspects of the system.

As explained more fully below, the ERP management system 150 may be arranged as a distributed processing system that operates responsive to programming instructions stored in memory and executed by one or more programmable processors or other controllers to realize a number of functional modules. Exemplary modules include a digital twin model 172, a semantic layer and semantic registry 174, AI agents 176 assigned to various operational tasks (including respective elements of the production system 100), orchestrators 178, a user plane 180, a data plane 182, a number of data table structures 184 including a Run Registry, a truth gate 186, and shared/tiered memory 188. Other elements can be incorporated as required.

While not limiting, it is contemplated that the ERP management system 150 will be server-based and accessible via a private or public network (including via the Internet) via various user network accessible devices (e.g., smart phones, tablets, terminals, laptops, desktop computers, workstations, etc.).

FIG. 3 shows an exemplary operational environment 200 in which various sensors (and other instrumentation) 202 associated with production aspects of the system 100 communicate production data via one or more production system I/F devices to a remote server 206 via a network 208.

Additional sensors 210 (and other instrumentation) associated with transport aspects of the system communicate the data to the server 206 via one or more transport system I/F devices 212. User access is provided via one or more user I/F devices 214. Validated data are communicated to a third party I/F device 216 to access various third-party services, including but not limited to the settlements carried out with the system 160 in FIG. 2. Various applications (apps) may be loaded to each of the respective I/F devices to carry out the various functions set forth in FIG. 2.

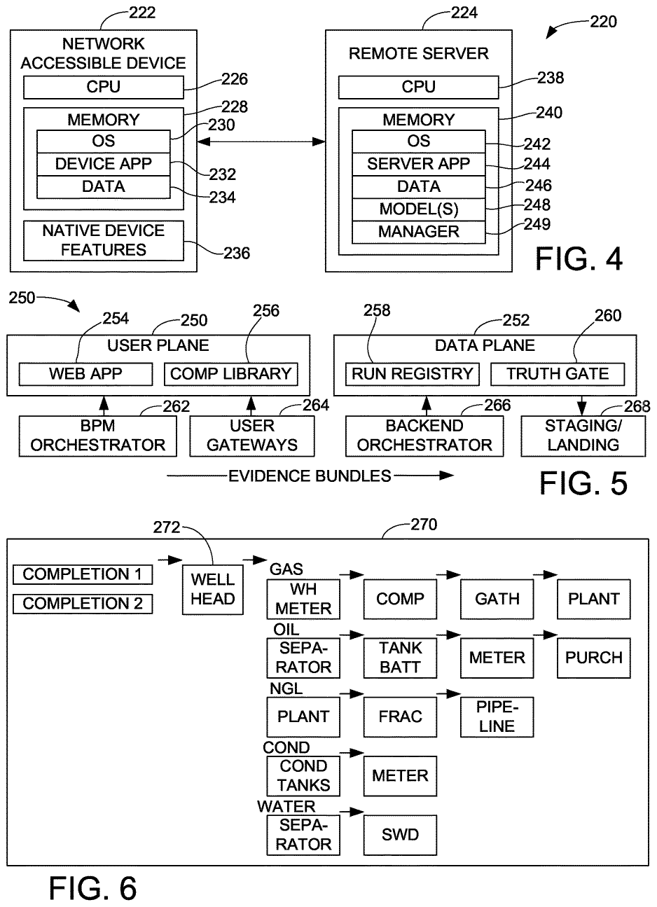

FIG. 4 illustrates a network accessible device 222 in communication with a remote server 224 to illustrate representative configurations of the respective I/F devices and server from FIG. 3 in some embodiments. As noted above, the device 222 may take the form of a handheld, portable or desktop phone, tablet, computer, etc. Other arrangements can be used. The device 222 includes a processor (CPU) 226 with associated memory 228 with various software modules including operating system (OS), a device app (232), and local data 234 used by the app (including history data, credentials, cryptographic elements, etc.). The device 222 may additionally have one or more native device features (e.g., touch pad, display, wireless communication, camera, sensors, etc.) that may be used as required to communicate or otherwise interface with the system 100.

The server 224 may be one or more private or public servers (including cloud, data center, web services, etc.) with one or more processors (CPU) 238 and allocated memory 240 with server OS 242, server app 244 for the ERP system, data store 246, one or more trained AI models 248 and one or more manager layers 249. Use of a server is contemplated but not necessarily required, as the functionality of the system can instead be arranged as a peer-to-peer distributed system among the various I/F devices that facilitate user access and interaction.

FIG. 5 is a functional representation of high-level architectural aspects of the ERP management system 150 in further embodiments. The system can be arranged around a user plane 250 and a data plane 252. The user plane 250 largely handles the human-input aspects of the system for various users including operators, owners, facility managers, auditors, regulators, and other interested parties. Different levels of data access and administrative control are provided based on responsibility and authority.

In some embodiments, the user plane 250 includes a web app portal 254 to facilitate user access to the system, including a digital twin representation of the system (see 172, FIG. 2) and a component library 256 from which design personnel can select elements to construct the digital twin model. The data plane 252 includes a run registry 258 which tracks and accumulates data during reconciliation processing by the system, and a truth gate 260 that evaluates and provides validation of calculations and other data prior to posting.

A BPM orchestrator 262 provides semantic control of the user plane, and a backend orchestrator 264 provides semantic control of the data plane. User access is provided via temporal user gateways 266, and a storage system 268 provides staging and landing of validated data.

FIG. 6 is a generalized view of a web app representation 270 accessible to users to observe and access the digital twin. The representation 270 is displayable on a user device (e.g., device 222 in FIG. 4) and is arranged as a number of tiles 272, or stages, corresponding to the physical system (see FIG. 1).

The respective tiles 272 can be accessed to display up to date data based on each of the five respective streams (gas, oil, NGL, condensate and water). Data associated with the system are displayed within each tile, such as allocation percentages (such as for each completion), working interest (WI), net revenue interest (NRI), and lease operating expense (LOE) obligations, and so on. By clicking on each tile, the user can observe an expansion block (not separately shown) that displays additional values, calculations, revenue amounts, rates, production values (e.g., barrels, MCF, etc.), gross allocations, transport rates, etc. The basis for each calculation is shown, indications are provided whether the data have been agent verified, and whether additional steps, including human verification, are pending.

In this way, the system proceeds to generate in computer memory a digital twin of a physical hydrocarbon production system that produces a plurality of hydrocarbon streams, such as the system 100. This system is modeled internally and can be displayed via the display in FIG. 6. Data are accumulated during operation from the various sensors and instrumentation in the physical system, and the AI agents generate evidence bundles of related data associated with the workflow corresponding to the operations and parameters experienced within the system for each hydrocarbon stream.

More particularly, each evidence bundle represents the execution of a reconciliation process and includes all data relevant to the reconciliation of some required validated parameters/values within the system. Evidence bundles can include but are not limited to raw measurements, intermediate calculations, model prompts and responses, validation results, human decisions, attachments, and posting records, among others. Evidence bundles are stored in an object storage system (e.g., block 268) with versioned hashes. Each bundle is keyed by a run_id unique identification value and is accessible to auditors, compliance reviewers, and operations personnel. The evidence bundles enable replay, verification, and regulatory audit of any reconciliation run.

The truth gate 260 provides a deterministic validation and posting boundary. Agents may generate candidate outputs such as reconciled volumes, allocated ownership shares, revenue distributions, posting instructions, etc., but these candidates cannot directly modify systems of record. Instead, all candidate outputs are submitted to the truth gate for each agent and, as required, human validation.

The truth gate validates candidate outputs against at least one predetermined criterion such as curated truth surfaces, semantic validations, and deterministic rules. In some cases, each of these criteria are applied, and only if all validations pass does the truth gate commit the outputs to the system of record. Each evaluation may result in calculation of a confidence score, and the truth gate validates based on the calculated confidence score exceeding a predetermined confidence threshold. Posting operations are idempotent and may include compensation logic to correct prior postings if discrepancies are later detected. If validation fails such as an insufficient confidence score, the truth gate raises an exception to the human workflow system via the user plane for review and approval.

As a result, the system operates based on rules, contract terms, taxing levels, calibration values, correction factors, and other data inputs to provide up-to-date and historical performance of the system. In further embodiments, validated data are ported to an appropriate ledger system for settlement. All data elements are tracked through the system, allowing immediate and transparent auditing and other compliance verification.

The following sections provide additional embodiments, architectural detail, and operational flows that further describe and enable the systems and methods as disclosed herein. These embodiments expand upon the digital-twin modeling, semantic governance, agent-based computation, reconciliation workflows, and deterministic validation mechanisms described above in FIGS. 1-6. The following description also describes a multi-tier distributed-ledger architecture, a formal Run Registry schema, an Evidence Bundle registry, and a mathematically defined Truth Gate scoring engine that governs promotion of machine-generated outputs to semantic state. Further details regarding specific terminology or architectures may be found in the accompanying provisional applications that have been incorporated by reference into this disclosure.

As noted previously in FIG. 5, the system is arranged around two primary operational planes: a data plane and a user plane. The data plane executes machine-driven ingestion, calculation, reconciliation, and validation workflows. The user plane executes human-driven exception handling, approvals, and corrective actions. Each plane is governed by a dedicated orchestrator, and the planes interact through a structured alerting and resolution mechanism. The processing by the data plane is validated by a truth gate, which applies deterministic and scoring (probabilistic) verification of each reconciliation run. Validated data are thereafter stored for settlement and post-auditing historical and regulatory requirement purposes.

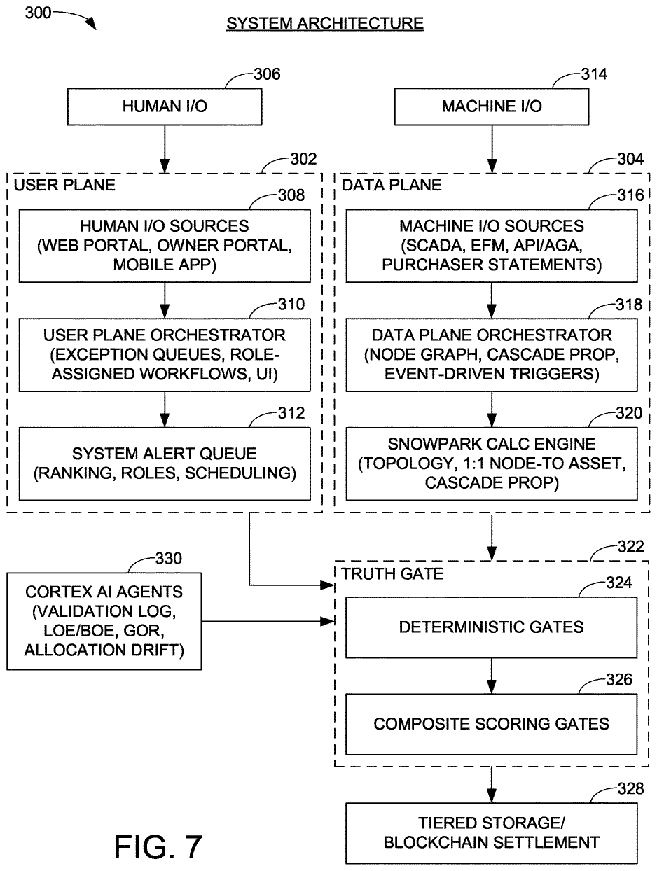

FIG. 7 provides a functional block representation of a system architecture 300 in accordance with some embodiments to set forth these and other operations. The architecture of FIG. 7 is similar to the architecture described previously in FIGS. 1-6 and includes a user plane 302 and a data plane 304, as before.

The user plane 302 receives human based inputs from human I/O (input/output) devices 306 such as processor-based devices upon which software in the form of web portals, owner portals, mobile apps (including the app described previously in FIG. 6), and so on are executed. These human inputs are directed to the user plane 302 and are handled by a human I/O sources processing block 308.

A user plane orchestrator 310 directs various operations to coordinate the human actions, such as the generation and maintenance of exception queues, role assignments, work flows, etc. A system alert queue 312 is a mechanism that receives flags and other signals from the data queue 304 requiring human attention and resolution.

The data plane 304 receives various machine-side data and inputs from external machine I/O devices 314. These can include the various sensors, meters, and other instrumentation described previously, as well as other sources of machine I/O inputs. A machine I/O sources processing block 316 handles and directs these machine I/O inputs. Without limitation, examples of machine I/O data can include SCADA (Supervisory Control and Data Acquisition) data, EFM (Electronic Flow Measurement) data, API (American Petroleum Institute) data, AGA (American Gas Association) data, generated documents such as purchaser statements, etc.

As will be recognized, SCADA is a real-time telemetry and control system that can be used across production facilities. It collects continuous or near-continuous operational data from field equipment and transmits it to a central server. Without limitation, SCADA data can include flow rates (gas, oil, water), pressures (tubing, casing, separator, line), temperatures, valve positions, pump status (on/off, speed), tank levels, compressor states, alarm conditions, and other forms of instrumentation data. By contrast, EFM is a custody-grade measurement produced by flow computers at the wellhead, separator, or sales point. EFM devices calculate volumes using AGA/API standards, and the data are delivered in regularly scheduled intervals such as every minute, every 5 minutes, every 15 minutes, every hour, etc.

A data plane orchestrator 318 is responsible for ingesting the raw operational data and performing various data manipulation operations including generation of node graphs, handling workflows and cascade propagation, and identifying event driven triggers. Calculations are handled by a controller unit, which in this case is characterized as a Snowpark calculation engine 320.

In some embodiments, the data plane 304 receives the aforementioned machine-generated inputs including SCADA data, EFM interval data, purchaser statements, plant statements, tank readings, and other instrumentation data, and populate a number of structured tables which, for convenience, are described herein as M06_EFM_INTERVAL_DATA, M01_METER_READINGS, and V05_PURCHASER_STATEMENTS.

The data-plane orchestrator 318 executes a deterministic traversal of the semantic node graph defined in A02_ASSET_RELATIONSHIPS. Each node corresponds to a physical or logical component of the production system. When an upstream node value changes, cascade propagation automatically triggers recalculation of all dependent downstream nodes. In some embodiments, cascade propagation executes in under 300 milliseconds.

The data plane 304 maintains node-level execution state in N04_NODE_STATUS, which may include statuses such as OK, WARN, FAIL, INCOMPLETE, or GRAY (blocked by upstream failure). These statuses are updated automatically as data changes propagate through the system. More information on example calculations is provided below.

At this point it will be observed that the outputs from the data plane 304 and, as required, the user plane 302 are directed to a truth gate 322. The truth gate 322 may be viewed as the terminal end processing aspects of the data plane 304, but the truth gate 322 is depicted as a separate module in FIG. 7 for ease of discussion.

The truth gate 322 performs two levels of validation; a deterministic evaluation as shown by deterministic gates 324, and a composite (probabilistic) scoring evaluation as shown by composite scoring gates 326. Depending on the deterministic and probabilistic operation of these respective modules 324, 326, the data associated with a given reconciliation run are either validated and passed for further processing including data recordation and settlement, block 328, or exceptions are reported back for resolution by other aspects of the system including the user plane 302, data plane 304 or cortex AI agents 330.

In some cases, the system alert queue 312 can be used to flag exception events during truth gate processing, requiring human interaction before the truth gate 322 can make its final determination. Alerts may include severity levels such as CRITICAL, HIGH, MEDIUM, or WARN. CRITICAL alerts correspond to deterministic gate failures (e.g., DOI sum failure, mass balance failure, curative block). HIGH and MEDIUM alerts correspond to AI-detected anomalies or data quality issues. WARN alerts correspond to agent-detected drift or low-confidence conditions.

The deterministic validation layer enforces schema-level rules that must be satisfied before any machine-generated output may be promoted to semantic state (e.g., finally validated and settled values). These rules are non-overridable and are enforced prior to any probabilistic evaluation.

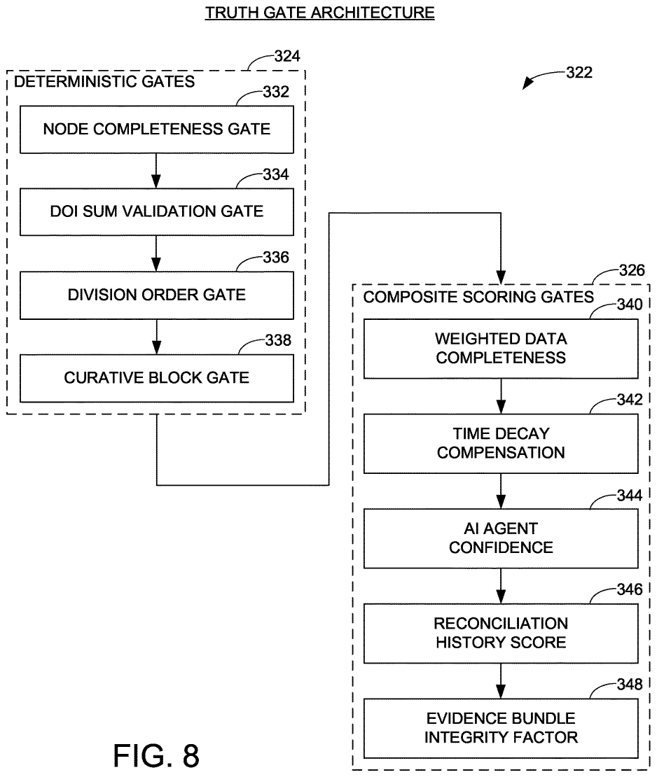

FIG. 8 shows the truth gate 322 in greater detail in accordance with some embodiments. It will be appreciated that the arrangement in FIG. 8 is merely exemplary and is not limiting, as other arrangements can be used for the current oil & gas environment as well as for other operational environments. In this embodiment, there are four (4) deterministic gates 324 and five (5) scoring (probabilistic) gates 326. The deterministic gates 324 include a node completeness gate 332, a DOI sum validation gate 334, a division order gate 336 and a curative block gate 338. The probabilistic gates include a weighted data completeness gate (or stage) 340, a time decay compensation stage 342, an AI agent confidence stage 344, a reconciliation history score stage 346, and an evidence bundle integrity factor stage 348. Each of these will be discussed in detail below.

The node completeness gate 332 evaluates a variable N01_NODES which defines min_completeness_pct for every node. If an upstream meter reading is missing, the completion node fails in a value referred to as N04_NODE_STATUS, an alert fires in the system queue 312 (SYS02_ALERT_QUEUE), and the entire downstream cascade is blocked. Nothing downstream executes on incomplete data.

The DOI (Division of Interest) sum validation gate 334 operates to ensure that all data values that must sum up to exactly 100% do in fact sum up to this level, up to eight decimal places of precision. Examples include ownership percentages, allocations among parties, and any other form of data where an exact 100% allocation is required. These values must meet this criteria before any row can be written to the so-called V02_DOI_DISTRIBUTION table; the sum of all ri_decimal values for a given completion/date/commodity must equal exactly 1.0000000±0.0000001. A sum of 0.9999999 is a FAIL, in which case distribution is blocked until correction via the alert queue or other agent operations are taken to resolve.

The division order gate 336 evaluates the correctness of all division orders; revenue cannot be distributed to an owner whose Division Order is not in a correct and verified do_returned status. This is enforced by the schema, not by application logic.

The curative block gate 338 optionally provides a validation of all land title issues are correct, complete and not under dispute. When a value referred to as L08_LAND_CURATIVE carries a HIGH-priority open defect on a unit, the gate 338 fires a CURATIVE_BLOCK alert in SYS02_ALERT_QUEUE that halts division order execution entirely until the title defect is resolved.

The deterministic gates 324 ensure prevention over reconciliation in a low trust environment. The deterministic rules aren't configurable thresholds that the AI evaluates, but are rather hard stops encoded at the schema level with no override path. This makes entire classes of errors structurally impossible to propagate through the system.

The truth gate 322 can use the agents 330 (FIG. 7) on the front end to validate various calculations against system configuration and measurements, such as LOE/BOE against N05_FIELD_BENCHMARKS, flag allocation drift, project take-or-pay shortfalls, and so on. These elements can generate WARN or HIGH alerts, which flow to human review. The AI can be wrong, and the system routes those situations to humans for verification for proceeding to perform the deterministic evaluation. The deterministic layer (gates 332, 334, 336, 338) generates CRITICAL alerts and blocks execution with no exception path. No agent recommendation, no user override, no configuration flag can be used to bypass these structures. Rather, the schema enforces the rule before the AI is even consulted.

FIGS. 7-8 demonstrate the back-and-forth data flow interactions described previously between the user plane 302 and the data plane 304: if the machine processing hits a deterministic gate that cannot be passed, the system issues a CRITICAL alert to the user plane, a human corrects the underlying data (DOI decimals, missing meter reading, curative resolution), the data re-enter the data plane, and the gate re-evaluates. For probabilistic/AI concerns a similar loop is used, but the flow is routed through WARN/HIGH alerts with human judgment involved in resolution. The deterministic gates 324 are the reason that loop terminates cleanly, since there is no ambiguity about when and where data have passed.

Before continuing with further description of the truth gate architecture in FIG. 8, it will be helpful to provide additional details regarding a reconciliation process, since it is a reconciliation process that is being validated by the truth gate 322. Generally, a reconciliation process is a bounded comparison operation in which the system's computed values are placed side-by-side with an external party's reported values, the variance is measured, classified, and driven to a terminal state.

The present disclosure contemplates at least four distinct reconciliation types, each with its own table and its own shape: (1) Purchaser statement recon (V05): this is the system's calculated volume/price/amount vs. what the purchaser reports on their run statement; (2) Gas plant recon (V08): this is the calculated inlet MCF and NGL yield vs. the processor's settlement statement; (3) Payment variance tracking (V06): this is the expected vs. received amounts at the owner distribution level; and (4) Cash true-up (J07): this is the AFE/cash call estimated cost vs. actual at operations close. Other reconciliations can be utilized as well, so these are merely illustrative and not limiting. It will be noted that each of these has the same logical structure: a scope, a trigger, a comparison, a variance decision, and a resolution path.

Initiation paths are multiple. The data completeness model means a purchaser statement arriving and populating V05 is itself an event trigger; the system does not wait for a human to kick off reconciliation, but rather, fires automatically when the inbound data lands. A gas plant statement arriving in V08 is handled the same way. Month-end close workflow triggers reconciliation runs on schedule across all open periods. In addition, manual initiation from the user plane is always available; for example, a revenue accountant can explicitly launch a recon run against a specific well, period, counterparty, etc.

The definition of a reconciliation run has four components: (1) scope, (2) comparison pairs, (3) tolerance thresholds, and (4) acceptance criteria. The scope identifies the respective asset_ids, production period, counterparty statement, and so on. The comparison pairs involve the system calculated values (sourced from V01, PR02, P03, P04 depending on recon type) being compared against the external party's reported values. This involves the digital twin modeling of the system, since the digital twin is compared for variance to the reported values from the physical processing operation. The tolerance thresholds are denoted as recon_tolerance_pct and define when a variance is acceptable vs. when it escalates. The acceptance criteria identify what terminal states constitute a satisfied run (e.g., MATCHED, WITHIN_TOLERANCE, RESOLVED).

The run_ID is the handle that binds all of this into a single auditable unit. The run_ID enables the system to determine whether a given agent action, calc result, or alert belongs to the current reconciliation execution vs. a prior attempt or a re-run. The Run Spine accumulates everything under that handle: the trigger event, the scope definition, each comparison step and its result, every agent action from C03_AGENT_VALIDATION_LOG, every alert generated in SYS02, the iteration history if human correction loops occurred, and the final terminal status.

A reconciliation run reaches a satisfied state when all variance fields across all in-scope records fall within recon_tolerance_pct, or all out-of-tolerance variances have been explicitly resolved through V06 (with a credit_applied_stmt_id closing the loop), and any required human approvals are captured in the audit trail. At that point the run status moves to RESOLVED and the Run Spine is closed. If the variance exceeds tolerance and can't be resolved automatically, it escalates to a RECON_VARIANCE CRITICAL alert in SYS02, blocking period close until a human disposition is recorded.

Significantly, an unresolved variance at month-end does not just sit open, but rather, blocks period close. For example, tank inventory variances in P07, hauling ticket mismatches in P08, and purchaser statement variances in V05 are all explicitly described as blocking close if unresolved. In this way, the system will not close a period on top of an open reconciliation. The run must be either satisfied or explicitly overridden with a disposition before the period locks.

Once the run is satisfied and the Run Spine is closed, that committed state is what triggers a smart contract. The blockchain does not just receive a record of the payment amounts, but rather provides the proof that the reconciliation process ran, passed, and authorized the settlement.

The Evidence Bundle is the complete, self-contained evidentiary record that proves a specific reconciliation run produced a specific result from specific inputs. The Evidence Bundle exists separately from the Run Spine (which is the process record) and separately from what goes on-chain (which is the hash and settlement instruction). The bundle is the underlying data that the hash represents, and is the information necessary to reconstruct or audit any result without having to query live operational tables.

The raw materials of an Evidence Bundle are defined in the so-called CA01_CALC_RESULTS: the value input_snapshot_json stores the complete JSON of all input values at the time of calculation, input_hash is the SHA-256 of those inputs, and output_hash is the SHA-256 of the result. As desired, the IPFS (Inter Planetary File System) can be used as a mechanism for external storage for large data objects, with the IPFS hash anchored on-chain. The Evidence Bundle formalizes those concepts at the reconciliation process level rather than the individual calculation level.

Without limitation, example Evidence Bundles can include the following:

Purchaser Statement Bundle (V05-type): the inputs are the system's independently calculated volume, price, and net amount alongside the purchaser's reported values from their run statement using the actual documents, parsed and structured as required. The bundle contains the raw purchaser statement (PDF/EDI as received, unmodified), the calc chain showing how each field was derived (linked calc_result_ids from CA01), the side-by-side comparison with each variance field populated, the tolerance decision and who/what made it, and if escalated, the V06 variance record and its resolution. This bundle is the authoritative record if a purchaser ever disputes a volume or price; the bundle can be used to show exactly what was calculated and what was reported, with cryptographic proof neither has been altered.

Gas Plant Statement Bundle (V08-type): this bundle is more technically complex because it involves additional values such as shrinkage factors, NGL fractionation yields, and keep/return splits. The bundle contains the system's P04_NGL_FRACTIONATION calculations, the plant's reported inlet MCF and yield percentages, the inlet variance and NGL variance computations, and the governing gas processing agreement terms that define acceptable variance. Long term, this bundle can be important for contract renegotiation, since sustained inlet variance over multiple periods can be a factual basis for a measurement dispute or contract amendment.

DOI/Revenue Distribution Bundle (V02-type). This is the most legally sensitive bundle, as it includes a complete DOI snapshot at the time of distribution (e.g., all eight DOI snapshot fields that V02 locks immutably), along with the gross revenue calculation inputs, every owner's ri_decimal and resulting share, the DOI sum validation result (proving it equaled 1.0000000), and the Division Order lifecycle status for each owner at that moment. This bundle is the main evidence that would be used to resolve a royalty dispute. Because this bundle captures the DOI state at the exact moment of distribution, it proves what the ownership was then, even if the DOI has since been amended.

Prior Period Adjustment Bundle (V07-type). This bundle is structurally arranged as a linked pair: the original bundle from the period being corrected, plus the correction event record. The correction side contains the error type, the delta values (volume_delta, revenue_delta), the reversal_journal_id and rebooking_journal_id proving GL entries were properly unwound and rebooked, and if regulatory, the amended_report_ref. The linkage allows traversal from the correction backward to the original transaction, and forward to the amended filing. This is what satisfies an auditor asking, “show me every adjustment made to this well's revenue in calendar year 2025.”

JIB/Cash Call True-Up Bundle (J07-type): this bundle can include the original AFE budget, each cash call amount and collection record, actual costs incurred (from J01_JIB_HEADERS through J03_JIB_LINE_ITEMS), the reconciliation_variance between estimated and actual, and the true-up distribution by owner WI decimal. For non-consent elections, this bundle also captures the penalty mechanism calculation. Long term, this bundle feeds into AFE performance analytics, enabling assessment of whether the original estimate was accurate, what drove overruns, etc.

As noted above, these and other forms of Evidence Bundles can be generated as required. The Evidence Bundles have both short term and long term utility. In the short term, that is to say from run completion to period close, the Evidence Bundle operates as a dispute resolution artifact, a period close gate, and feeds the system alert system. For example, if a purchaser calls with a question about their statement, the bundle can be retrieved by run-id and the comparison data is immediately available without reconstructing anything from live tables. Similarly, when a revenue accountant opens a RECON_VARIANCE alert, the alert will show a summary view of the bundle's variance fields.

In the long term, the Evidence Bundle serves various regulatory, legal and training requirements. Some states regulatory and tax authorities require record retention for a certain number of years (such as 7 years), and so the Evidence Bundle can be maintained for these periods of times to support governmental audits, investigations, litigation, etc. Bundles can also be used for future training (with appropriate data redactions). For example, The schema's C03_AGENT_VALIDATION_LOG captures agent confidence scores, and bundles with known-correct resolutions are ground truth for model refinement. Short term use may provide storage of the Evidence Bundle locally, while long term use may provide transfer of the Evidence Bundle to long term, cold storage (e.g., IPFS, etc.).

Returning again to FIG. 8, it will now be understood that the truth gate 322 does not evaluate a single value or calculation, but rather evaluates a candidate output, meaning a proposed result produced by the calc engine for a specific node, for a specific production period, under a specific run-id. The question the gate answers is: “Is this output trustworthy enough to transition this particular reconciliation run from Proposed state to Semantic state?” That transition is irreversible in the operational sense; once classified as Semantic (verified), it is the truth that downstream nodes, revenue calculations, and DOI distributions will rely on.

As noted previously, the truth gate 322 has a deterministic gate section (Tier 1) 324 and a probabilistic gate section (Tier 2) 326. The deterministic gates of Tier 1 are binary gate conditions that veto promotion to Semantic state regardless of what the probabilistic gates (Tier 2) produces. Any failure is rerouted for resolution before proceeding.

The Tier 2 probabilistic scoring section calculates a composite score along five so-called dimensions (D1 through D5), corresponding to the gates 340-348.

The weighted data completeness gate 340 (D1): this generates a completeness_score=Σ(field_weight[i]×field_completeness[i])/Σ(field_weight). Field weights range from 0.1 to 1.0 based on criticality to the output. The field_completeness[i] value is 1 if present and valid, 0 if missing. Weights are context-adjusted dynamically; for example, a gas analysis field may be assigned a higher weight for a GOR calculation than for a wellbore aggregation node. The same field can carry different weights in different calc contexts.

The time decay compensation gate 342 (D2): this gate evaluates “data freshness,” and provides a value data_freshness_threshold_hrs on N01_NODES which defines how stale an input can be before it degrades the completeness score. For example and not by way of limitation, a well test allocation factor at 47 days old may score a reduced value of 0.88, whereas a well test allocation factor from just a few days ago may receive a full 1.0. The decay function is not a step change but continuous, so older data progressively erodes the score rather than suddenly triggering a failure. This generates MEDIUM alerts at degraded-but-not-failed thresholds.

The AI agent confidence gate 344 (D3). This value is taken from the so-called C03_AGENT_VALIDATION_LOG where each agent validation multiplies a confidence factor into a running score. For example, a completeness deficiency multiplies by 0.8, a DOI calculation error multiplies by 0.7, and so on. These are not arbitrary values, but rather, represent the probabilistic weight of the specific failure type on overall output reliability. The composite agent confidence is the product of all agent multipliers applied to this candidate output under this run-id. Empirical and trained model analyses can be used to arrive at appropriate values.

The reconciliation history score gate 346 (D4): this calculation evaluates the consistency of a new calculation with previous calculations. For example, when the truth gate evaluates a candidate output, it looks up the reconciliation history for this particular node/period scope, including the prior run-id records for reconciliation runs covering this same well, this same period, this same counterparty. If prior runs resolved MATCHED or WITHIN_TOLERANCE, the reconciliation history contributes a positive factor to the composite score. If prior runs had VARIANCE_FLAGGED or INVESTIGATION status, the history contributes a penalty. This makes the Truth Gate contextually aware of whether this class of output has been problematic before. The run-id connects a candidate output to its reconciliation history.

The evidence bundle integrity factor gate 348 (D5): When a reconciliation run has been completed and an evidence bundle extracted, the bundle hash is keyed to the assigned run-id value, and both of these are available for lookup. The truth gate can verify that the candidate output's input_snapshot_json (from CA01) hashes to a value consistent with the committed evidence bundle. If the hashes match, meaning the inputs that produced this candidate output are identical to the inputs that were reconciled and committed, the integrity factor is set to 1.0. If there is any divergence (inputs changed after reconciliation completed), the integrity factor drops to 0.0 and the output cannot advance to Semantic state. This closes a critical attack surface: without this check, a candidate output could be promoted to truth using inputs that were modified after the reconciliation that validated them.

The five-dimension composite produces a single truth_score in [0.0, 1.0]. The disposition logic is:
1. truth_score≥threshold AND all deterministic gates PASS: PROMOTE to Semantic, lock SHA-256 hash, write to C01 audit trail, eligible for blockchain commit.
2. truth_score in [warn_threshold, threshold): WARN, output enters N04_NODE_STATUS as WARN (yellow), SYS02 gets a MEDIUM or HIGH alert, human review required before promotion.
3. truth_score<warn_threshold→FAIL, output blocked, N04 status FAIL (red), CRITICAL or HIGH alert, human correction required.

Without limitation, the thresholds can be established as follows:

| | |
|---|---|
| truth_score ≥ 0.95: | AUTO-PROMOTE to Semantic state |
| 0.80 ≤ truth_score < 0.95: | WARN - human review required |
| truth_score < 0.80: | FAIL - blocked, CRITICAL/HIGH alert |

Other threshold values can be used. The reconciliation process interacts upstream of the gate: its run-id is the reference that the gate's Dimension 4 looks up to retrieve reconciliation history. A completed, satisfied reconciliation run covering a node's scope elevates that node's truth score on future evaluations. An unresolved reconciliation actively penalizes it.

The evidence bundle interacts at Dimension 5: it is the integrity check that confirms the inputs being evaluated now are the same inputs that passed reconciliation. The bundle hash keyed to run-id is the lookup key. If no bundle exists for the current scope, Dimension 5 contributes 0, pulling the composite score down and making automatic promotion less likely.

The run-id itself is the structural element that makes all of this traceable. It appears in four places: it indexes the reconciliation history in Dimension 4, it keys the evidence bundle lookup in Dimension 5, it is recorded in the Truth Gate's scoring record when a promotion occurs, and it is carried into the blockchain commit as provenance. This means any promoted Semantic output can be traced backward through its truth_score, through the evidence bundle, through the reconciliation run, and all the way to the raw inputs in a single hash-linked chain.

In this way, these embodiments provide a truth scoring system that incorporates prior reconciliation run history indexed by run-id as a dynamic input to the promotion decision for a candidate output, such that the trustworthiness of a new output is evaluated in part by the resolution history of prior outputs in the same scope class. This is not merely data validation, but rather represents context-aware, history-weighted truth determination.

The composite truth_score can be calculated as follows:
truth_score=(W1×completeness_score)
   +(W2×freshness_score)
   +(W3×agent_confidence)
   +(W4×recon_history_factor)
   +(W5×bundle_integrity_factor)

Each of the W1-W5 values are weighting values, and the various scores and factors are calculated as follows. It will be appreciated that this is merely exemplary and not limiting, as other composite scoring mechanisms can be used as desired.

Completeness Score (D1):
completeness_score=Σ(field_weight[i]×field_present[i])/Σ(field_weight[i])
field_weight[i]=base_weight[i]×context_multiplier[i]
field_present[i]=1 if field populated and valid, 0 if missing
context_multiplier=dynamically assigned per calc_method on N01_NODES

Freshness Score (time decay−D2):
age_hrs=current_timestamp−input_data_timestamp freshness_score=max(0, 1−(age_hrs/data_freshness_threshold_hrs))

At age 0: freshness_score=1.0

At threshold (e.g. 48 hrs): freshness_score=0.0

At 47days/1128 hrs vs threshold of 1440 hrs: freshness_score=0.217 contributing a weighted value of 0.043 to the composite truth score at W2=0.20, [0.0, 1.0], continuous decay

AI Agent Confidence Score (d3):
agent_confidence=Π(confidence_multiplier[j]) for all agents j that validated this node/period

Per C03_AGENT_VALIDATION_LOG: completeness deficiency: ×0.80
DOI calculation error: ×0.70
GOR/benchmark deviation: ×0.90
allocation drift flag: ×0.85
no issues found: ×1.00

Agent confidence is a running product—each successive agent finding degrades it multiplicatively; range: [0.0, 1.0]

Reconciliation History Factor (d4):
recon_history_factor=f(prior run terminal statuses for same asset_id+period scope)
MATCHED or WITHIN_TOLERANCE: 1.00
No prior run exists: 0.80 (neutral penalty—unverified)
RESOLVED (human dispositioned): 0.90
VARIANCE_FLAGGED/open: 0.50
INVESTIGATION/unresolved: 0.25

Where multiple prior runs exist, weighted average by recency:

$$recon\_history \_factor = \sum ( run\_weight [ k ] \times status\_score [ k ] ) / \sum ( run\_weight [ k ] ) \\ run\_weight [ k ] = 1 / ( 1 + days\_since \_run [ k ] ) ( recency weighting ) \\ range : [ 0. \text{.1} \text{.0} ]$$

Bundle Integrity Factor (d5):
SHA-256(current input_snapshot_json)==bundle_hash[run_id]: 1.0
No committed bundle exists for this scope/run_id: 0.8
p Hash mismatch (inputs changed post-reconciliation): 0.0 range: {0.0, 0.8, 1.0}—not continuous, intentionally discrete

Composite Score with Default Weights and Thresholds:

$$truth\_score = ( W 1 \times D 1 ) \times ( W 2 \times D 2 ) \times ( W 3 \times D 3 ) \times ( W 4 \times D 4 ) \times ( W 5 \times D 5 )$$

W1=0.30 (completeness—highest, foundational)
W2=0.20 (freshness)
W3=0.20 (agent confidence)
W4=0.15 (reconciliation history)
W5=0.15 (bundle integrity)
Σ weights=1.00
   truth_score≥0.95: AUTO-PROMOTE (pass)
   0.80≤truth_score<0.95: WARN (human review required)
   truth_score<0.80: FAIL (blocked)

The foregoing thresholds and weights are configurable per node type; for example, a REVENUE_CALC node may require 0.98 for auto-promotion while a WELLBORE_AGG node might allow 0.90, reflecting the different downstream consequences of error in each context. The values can also be adaptive adjusted over time based on performance.

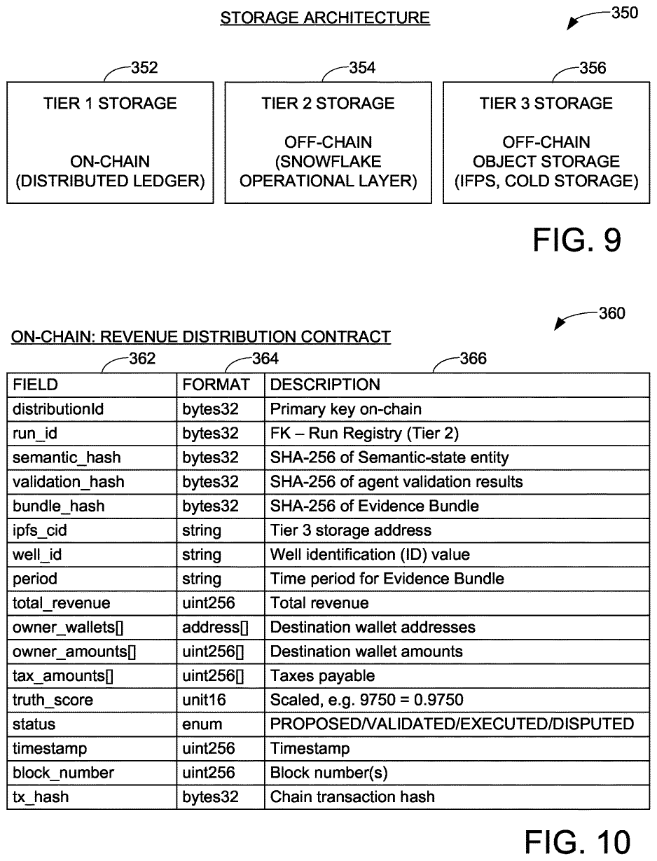

FIG. 9 shows a storage architecture 350 that can be used with some embodiments. The storage architecture is multi-tiered with different levels of access and storage. The arrangement in FIG. 9 is merely illustrative and not limiting.

The architecture 350 uses three tiers of storage referred to as Tier 1 352, Tier 2 354 and Tier 3 356. The Tier 1 storage 352 constitutes a local private distributed ledger (blockchain) to which various elements are written including hashes, pointers, settlement instructions, and cryptographic receipts. All operational data, such as the Run Registry and Evidence Bundles live off-chain and are not stored to the ledger 352. What goes on-chain makes everything off-chain independently verifiable and immutable without storing any of it on the chain itself.

The Tier 2 storage 354 may be local storage at the Snowflake operational layer and includes working data during reconciliation runs prior to settlement. Examples can include operationally live Run Registry tables, schema tables (V05, V06, CA01, C01, C02, N04), active reconciliation state, Bundle Registry index, and so on. It is contemplated that the data in Tier 2 are still under evaluation and are mutable until the settlement process is completed.

The Tier 3 storage 356 is off-chain object storage, such as (IPFS/cold storage/remote server storage). These are large data sets that are immutable once written, content-addressed by hash Evidence Bundles, and can include input_snapshot_json archives, inbound source documents (purchaser PDFs, plant statements, raw EFM data), and other historic, settled data.

For a revenue distribution event, the on-chain settlement contract data written to the ledger (Tier 1) 352 can include the various data shown in FIG. 10, which provides an on-chain revenue distribution contract format table 360. The table 360 includes variables (fields) 362, data formats 364, and a brief description 366. Other formats can be used. It will be noted that no actual operational data are stored to the blockchain, but can be accessed from the blockchain. While a private blockchain is contemplated, other arrangements can be used including a public blockchain, a commercially available blockchain through a third party (e.g., Etherium), etc. Merkle roots can be calculated and updated using known techniques to maintain validity and verifiability of the stored dat.

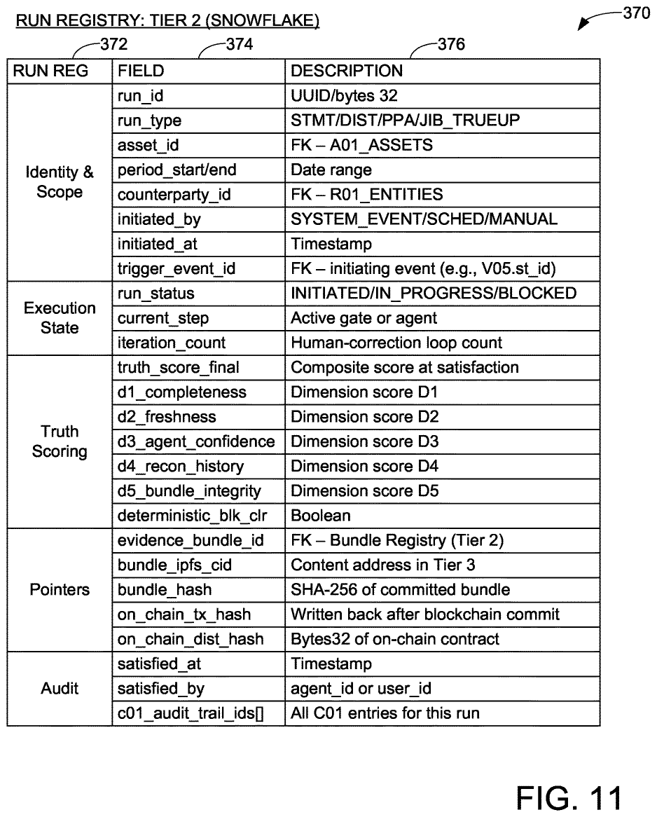

FIG. 11 shows a Run Registry format table 370 in accordance with some embodiments. As described previously, the Run Registry is maintained in local storage (e.g., Tier 2 working storage 354) and tracks various ID and scope parameters, execution states, truth scoring and pointers (categories 372). Variables are set forth in fields 374 and descriptions of these values are set forth at 376.

The Run Registry provides a durable, queryable record of each reconciliation run. The Run Registry remains off-chain and is updated throughout the reconciliation lifecycle. The Run Registry run_id is embedded as a reference field in the on-chain contract, but the full process record never touches the chain. After blockchain commit, the tx_hash and distribution_id values are written back into the Run Registry, creating bidirectional linkage.

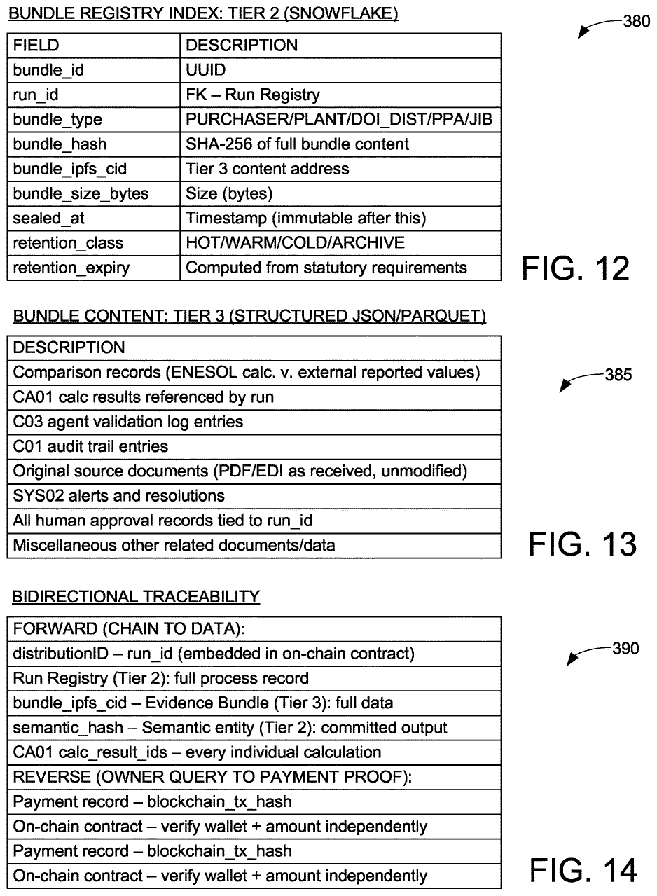

FIG. 12 shows a bundle registry index table 380, which is also maintained resident in Tier 2 storage. The index table 380 includes variables with associated descriptions as shown. The index table 380 allows ready access to bundle content which is stored in Tier 3 storage, as shown by content format 385 in FIG. 13. As noted previously, the content 385 of each Evidence Bundle can include comparison records (system calc vs. external reported values), CA01 calc results referenced by run, C03 agent validation log entries, C01 audit trail entries, original source document (PDF/EDI as received, unmodified), SYS02 alerts and resolutions, all human approval records tied to run_i, and other miscellaneous documents and data as required.

The system provides full bidirectional traceability, as represented by table 390 in FIG. 14. The cross-referencing of the various data structures allows both forwards and backwards tracing of data by blockchain transaction, Run Registry, Evidence Bundle, semantic entity, audit trail, calculation chain, period, id, or other access point. From a blockchain transaction hash, the system retrieves the distributionId, run_id, Run Registry record, evidence bundle pointer, and semantic entity. From an owner payment record, the system retrieves the blockchain transaction, verifies payment amounts, retrieves the evidence bundle, and verifies ownership decimals. Individual transactions can be easily extracted for verification without revealing other aspects of the transactions for other parties.

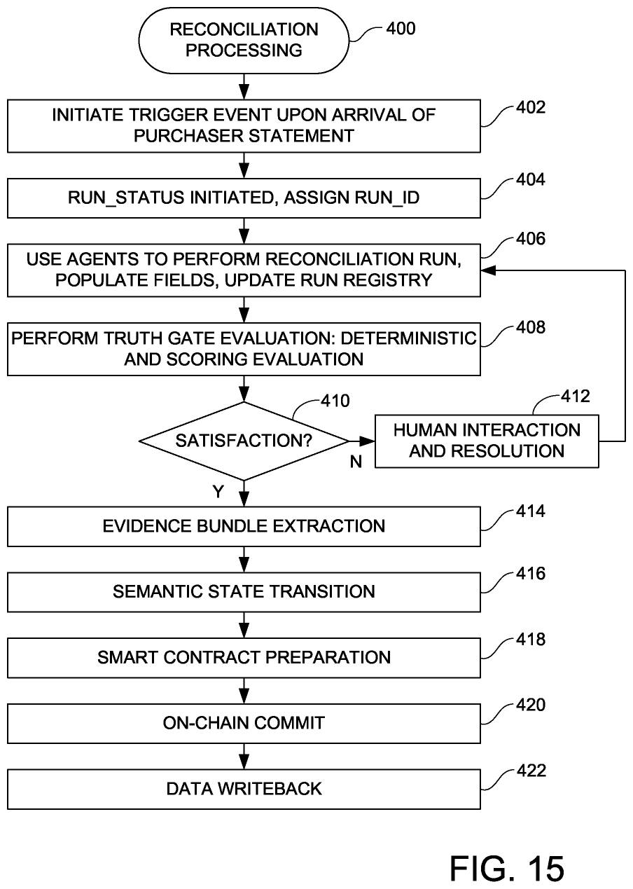

FIG. 15 provides a flow chart for a reconciliation processing routine 400 carried out in accordance with the foregoing discussion in some embodiments. It will be appreciated that the routine is merely illustrative and that various steps can be appended, omitted, performed in a different order, etc. as required. In the present example, it will be contemplated that the routine 400 undertakes a reconciliation process involving receipt of a purchaser statement. Similar steps would be carried out for the other types of reconciliation processing discussed herein.

At block 402, the process commences with a triggering event in which a purchaser statement arrives (such as in pdf format). The initial processing that is applied includes agent ingestation, which generates certain updates including a row in the V05_PURCHASER_STATEMENTS data structure row created (Tier 2). Run processing is initiated at block 404 including the assignment of a new run_id and the creation of a new Run Registry structure for the associated processing.

At block 406, agents proceed to perform reconciliation run processing, including calculations, population of fields, and updates to the run registry. In at least some embodiments, each associated agent fetches the system values from V01, PR02, P03 [Tier 2], fetches purchaser reported values from V05 [Tier 2], and populates variance fields in V05. Each agent action is logged in the C03_AGENT_VALIDATION_LOG row [Tier 2] and the C01_AUDIT_TRAIL row [Tier 2]. The Run Registry is also updated with a run_status=IN_PROGRESS [Tier 2].

When the data set is ready for verification, the process continues to block 408 where truth gate evaluation takes place as described above including in FIGS. 6-7. This can include both deterministic and probabilistic evaluation and scoring. As described previously, this processing can include gate reads of N01 thresholds, V05 variance, C03 confidence, prior run history, computation of a composite truth_score across 5 dimensions, and evaluate the results.

Decision block 410 shows that, should exceptions arise that fail, warn, and/or block settlement, the flow passes to block 412 where human and/or agent interaction and resolution activities are carried out. For example, lf WARN/FAIL flags are raised, SYS02 alerts are generated and handled through the user plane. In some cases, iteration loops are tracked and updated in the Run Registry so that the entire reconciliation process, including every human and agent interaction, is recorded.

Based on the exemplary criteria discussed above, satisfaction through the truth gate includes all variances≤recon_tolerance_pct, all 4 deterministic gates CLEARED, and a truth_score≥0.95. At this point, the Run Registry is provided with a final run_status=SATISFIED, satisfied_at=now. At this point, the flow continues to block 414 where a final immutable Evidence Bundle is extracted for storage (Tier 3). This includes operation of the system to assemble the bundle from V05, CA01, C03, C01, source PDF, and other data as required. The system calculates the SYS02 bundle_hash=SHA-256(assembled bundle content), and the bundle is written to Tier 3 storage. If the bundle is written to IPFS, the associated ipfs_cid address is returned [Tier 3]. The Bundle Registry index row is now created [Tier 2] and the Run Registry is updated with the bundle_ipfs_cid and bundle_hash values.

At block 416, the candidate output is now promoted from staging and proposed to Semantic (verified). A SHA-256 hash is generated and locked on the semantic entity C02_HASH_LEDGER, and updated with period Merkle root [Tier 2].

A smart contract is next prepared at block 418. A contract generator module reads in values including run_id, semantic_hash, validation_hash, bundle_hash+ipfs_cid, owner wallets/amounts from V02, truth_score, and proceeds to generate a smart contract instance.

The smart contact is thereafter deployed to the distributed ledger at block 420. This can include owner wallet amounts being settled, and DistributionExecuted tx_hash 30block_number returned from chain.

Finally, a data writeback operation is carried out at block 422. This includes Run Registry updates with on_chain_tx_hash, on_chain_distribution_id values, updates to the V02_DOI_DISTRIBUTION rows with blockchain_tx_hash, updates to the V11_OWNER_PAYMENT_REGISTER with created payment records, updated GL04/GL05 journal entries posted, update status to the C01_AUDIT_TRAIL with a final “SETTLED_ON_CHAIN” event, update to the C02_HASH_LEDGER with updated Merkle root. All of these can be maintained in Tier 2 storage for future indexing and referencing. Other data structures can be updated and maintained as well, so the foregoing are merely exemplary and are not limiting.

It will now be appreciated that the various embodiments provide a number of advantages over the existing art. While not necessarily limiting in all implementations, at least some embodiments provide a Run Registry that is not on-chain, but is maintained in local memory (e.g., Tier 2) for ready access. The run_id is embedded as a reference field in the settlement contract, but the full process record stays in Tier 2. The chain holds only the pointer, not the state machine. Evidence Bundles are also not on-chain, but stored securely for easy reference and retrieval.

The bundle_hash and ipfs_cid are stored on-chain, but bundle content lives in Tier 3 IPFS. The hash makes the bundle independently verifiable without the chain storing any of it. The chain can thus serve as the proof layer, not the data layer, which is both efficient and secure. Writing large structured data on-chain would be cost-prohibitive and unnecessary, since the hashes provide all the tamper-evidence needed. It will be appreciated that while SHA-256 hashes have been used in some embodiments, alternative and/or additional techniques, including private/public key encryption, digital signatures, and other forms of cryptographic processing, are readily contemplated and can be used as desired.

As a rule, PPAs will tend to not modify original records; prior period adjustments will be arranged as new smart contracts that link to original distribution contracts. The original tx_hash and block are permanent. The complete correction chain is traversable forward and backward. Merkle roots anchor entire periods, and the C02_HASH_LEDGER computes a Merkle root across all events for a given period. This means the entire month's reconciliation activity is cryptographically provable as a single verifiable checkpoint, not just individual transactions.

While various embodiments have been presented in the context of an multi-stream environment, the various embodiments presented herein are not so limited but can rather be adapted to any number of different applications, systems and environments as required.

Numerous possible variations and modifications will readily occur to the skilled artisan in view of the foregoing discussion, so it will be understood that the various exemplary embodiments disclosed herein are illustrative of, and are not limiting to, the scope of the claimed subject matter set forth below.

What is claimed is:

1. A computer-implemented method for validating a reconciliation run in an agent-based production reconciliation system, comprising:
executing, by a data plane of the system, a reconciliation run associated with a unique run identifier (run_id) to generate candidate outputs representing reconciled production values derived from accumulated measurements of a physical production system;
assembling, for the reconciliation run, an evidence bundle keyed to the run_id and comprising raw measurements, intermediate calculations, agent validation records, and a cryptographic hash of input data;
evaluating, by a truth gate executed by a programmable processor, the candidate outputs using at least one deterministic validation criterion that produces a non-overridable pass/fail result based on schema-level conditions of the accumulated measurements, and at least one probabilistic validation criterion that generates a numerical score representing a likelihood that the candidate outputs are trustworthy, the probabilistic validation criterion including at least a reconciliation-history factor derived from prior reconciliation runs associated with the run_id and an evidence-bundle integrity factor derived from comparing the cryptographic hash to a stored hash of the evidence bundle;
computing, by the truth gate, a composite truth score for the reconciliation run based on the probabilistic validation criterion; and
promoting the candidate outputs to a validated semantic state responsive to the deterministic validation criterion passing and responsive to the composite truth score exceeding a predetermined threshold, and blocking the candidate outputs from promotion responsive to either the deterministic validation criterion failing or the composite truth score falling below the predetermined threshold, wherein promotion to the validated semantic state authorizes posting of the candidate outputs to a system of record for settlement.

2. The method of claim 1, wherein the deterministic validation criterion comprises verifying that all required measurement nodes for the reconciliation run are present in the evidence bundle.

3. The method of claim 1, wherein the deterministic validation criterion comprises verifying that a sum of degrees-of-interest (DOI) for a product stream equals exactly one (1) up to a predetermined plurality of decimal places of precision.

4. The method of claim 3, wherein the predetermined plurality of decimal places of precision is eight (8) decimal places so that the deterministic validation criterion results in a pass for a value of 1.0000000±0.0000001 and results in a fail for a sum of 0.9999999 or lower.

5. The method of claim 1, wherein the deterministic validation criterion comprises verifying that a division-order ownership table is complete and internally consistent so that all owners of interest have legally certified entitlement claims.

6. The method of claim 1, wherein the deterministic validation criterion comprises verifying that no curative block is active for the reconciliation run.

7. The method of claim 1, wherein the probabilistic validation criterion comprises a completeness score based on a percentage of expected measurements present in the evidence bundle.

8. The method of claim 1, wherein the probabilistic validation criterion comprises a freshness score based on a recency of the measurements relative to a timestamp of the reconciliation run.

9. The method of claim 1, wherein the probabilistic validation criterion comprises an agent-confidence score derived from model-generated confidence values associated with intermediate calculations.

10. The method of claim 1, wherein the probabilistic validation criterion comprises a reconciliation-history score based on a weighted average of truth scores from prior reconciliation runs associated with the run_id.

11. The method of claim 1, wherein computing the composite truth score comprises applying a weighted combination of the probabilistic validation criteria.

12. The method of claim 1, further comprising writing data associated with the candidate outputs having the validated semantic state to a blockchain-based distributed ledger in a local memory of the system, and writing data associated with the evidence bundle to a cold storage data storage device.

13. The method of claim 1, further comprising generating and updating a Run Registry as a table structure in memory that records the run_id and data associated with each reconciliation run process, wherein the Run Registry is updated with a complete indication responsive to the associated candidate output receiving the validated semantic state indication from the truth gate.

14. The method of claim 1, further comprising utilizing an alert register of a user plane to process, via human input, a human-workflow exception event resulting from failure of at least one of the deterministic validation criterion or the probabilistic validation criterion of the truth gate.

15. The method of claim 1, wherein the reconciliation run is executed in connection with an oil and gas production system that generates a plurality of hydrocarbon and water streams comprising natural gas, natural gas liquids (NGL), oil, condensate, and produced water, and wherein the evaluating step applies the deterministic validation criterion and the probabilistic validation criterion to candidate outputs associated with at least one of the natural gas, NGL, oil, condensate, or produced water streams.

16. The method of claim 1, further comprising accessing a digital twin of the physical production system on a display of a network accessible device in a form of a web-based software application, the web-based software application displaying real time state of the physical production system including results generated by the truth gate module.

17. A system for validating a reconciliation run in an agent-based production reconciliation environment, comprising one or more processors and memory storing instructions that, when executed, cause the system to:
maintain a run registry that stores a unique run identifier (run_id) for each reconciliation run;
generate, for each reconciliation run, an evidence bundle keyed to the run_id and comprising raw measurements, intermediate calculations, agent-generated candidate outputs, validation artifacts, and a cryptographic hash of input data; and
execute a truth gate module configured to evaluate the candidate outputs using at least one deterministic validation criterion that produces a non-overridable pass/fail result based on schema-level conditions of the accumulated measurements, and at least one probabilistic validation criterion that generates a numerical score representing a likelihood that the candidate outputs are trustworthy;
wherein the probabilistic validation criterion includes at least a reconciliation-history factor derived from prior reconciliation runs associated with the run_id and an evidence-bundle integrity factor derived from comparing a hash of current inputs to a stored hash of the evidence bundle;
wherein the truth gate module computes a composite truth score for the reconciliation run based on the probabilistic validation criterion, promotes the candidate outputs to a validated semantic state responsive to the deterministic validation criterion passing and the composite truth score exceeding a predetermined threshold, and blocks the candidate outputs from promotion responsive to either the deterministic validation criterion failing or the composite truth score falling below the predetermined threshold; and
wherein promotion to the validated semantic state authorizes posting of the candidate outputs to a system of record for settlement comprising a blockchain-based distributed ledger.

18. The system of claim 17, wherein the deterministic validation criterion applied by the truth gate module is a pass/fail hard encoded test comprising each of the following: a verification that all required measurement nodes for the reconciliation run are present in the evidence bundle, a verification that a sum of Divisions of Interest (DOI) for a product stream equals exactly one (1) up to a predetermined plurality of decimal places of precision, and that a division-order ownership table is complete and internally consistent so that all owners of interest have legally certified entitlement claims.

19. The system of claim 17, wherein the probabilistic validation criterion applied by the truth gate module is composite numerical truth score comprising each of the following components: a completeness score based on a percentage of expected measurements present in the evidence bundle, a freshness score based on a recency of the measurements relative to a timestamp of the reconciliation run, an agent-confidence score derived from model-generated confidence values associated with intermediate calculations, and a reconciliation-history score based on a weighted average of truth scores from prior reconciliation runs associated with the run_id.

20. The system of claim 17, wherein the reconciliation run is executed in connection with an oil and gas production system that generates a plurality of hydrocarbon and water streams comprising natural gas, natural gas liquids (NGL), oil, condensate, and produced water, and wherein the truth gate module applies the deterministic validation criterion and the probabilistic validation criterion to candidate outputs associated with at least one of the natural gas, NGL, oil, condensate, or produced water streams.
